(19) United States
(12) Patent Application Publication
(10) Pub. No.: US 2015/0356930 A1
(43) Pub. Date: Dec. 10, 2015

(54) PIXEL CIRCUIT AND DISPLAY DEVICE EQUIPPED THEREWITH

(71) Applicant: PIXTRONIX, INC., San Diego, CA (US)

(72) Inventors: Takahide Kuranaga, Mobara (JP); Katsumi Matsumoto, Mobara (JP); Mitsuhide Miyamoto, Kawasaki (JP)

(21) Appl. No.: 14/762,353

(22) PCT Filed: Jan. 21, 2014
(86) PCT No.: PCT/IB2014/000229

§ 371 Date: Jul. 21, 2015

(30) Foreign Application Priority Data
Jan. 22, 2013 (JP) 2013-009187

(51) Int. Cl. G09G 3/34

(52) U.S. Cl. CPC G09G 3/3433; G09G 2300/0814; G09G 2320/0252; G09G 2300/0465

(57) ABSTRACT

[Problem] To provide a pixel circuit, and a display device provided therewith, that both reduces the number of transistors required for controlling an MEMS shutter and reduces the time for writing to a pixel.

[Means for Resolution]A pixel circuit is provided wherein a first transistor, a first capacitor, and a shutter portion are provided, where one terminal of the first capacitor is connected to an actuating power supply, the other terminal of the first capacitor is connected to one terminal of the first transistor and the shutter portion, and the other terminal of the first transistor is connected to a common electrode.

### FIELD OF TECHNOLOGY

The present invention relates to a pixel circuit and to a display device provided therewith. In particular, it relates to a pixel circuit that controls an MEMS shutter, and to a display device provided therewith.

### PRIOR ART

Given the need to conserve electric power, in recent years liquid crystal display devices have become popular. However, due to difficulties in increasing the numerical aperture of liquid crystal display devices, there have been major problems in further increasing the level of resolution and in reducing the backlight power consumption. Moreover, in a liquid crystal display device that controls the motion of the liquid crystal molecules, it is also difficult to achieve a high speed display. As an alternative to such a display method wherein the behavior of liquid crystal molecules is controlled, in recent years there has been great interest in display devices that use mechanical shutters (hereinafter termed “MEMS shutters” or simply “shutters”) through the application of MEMS (Micro Electro Mechanical Systems) technology (Patent Citation 1).

A display device that uses an MEMS shutter (hereinafter termed an “MEMS display device”) is a display device wherein the brightness of a pixel is adjusted through controlling the amount of light that passes through the shutter, through the use of TFTs to open and close the MEMS shutter for each individual pixel at high speeds. In most MEMS display devices, a time-gradation approach is used to display an image by sequentially switching light from red, green, and blue LED backlights. As a result, the MEMS display device requires no polarizing film or color filter, which are used in a liquid crystal display device, enabling the efficiency of use of the light from the backlight to be about 10 times as high, and enabling the consumption of less than half as much power, when compared to a liquid crystal display device, with the additional benefit of superior color reproduction.

In an MEMS display device, an MEMS shutter, and a switching element for driving the MEMS shutter, are formed on a substrate.

### PRIOR ART CITATIONS

### Patent Citation

[Patent Citation 1] Japanese Unexamined Patent Application Publication 2008-197668

### SUMMARY OF THE INVENTION

### Problem Solved by the Present Invention

In order to further increase the level of resolution of MEMS display devices, it is necessary to reduce the time for writing to the pixels, that is, it is necessary to increase the speed of the pixel circuits for controlling the opening and closing of the shutters. Moreover, typically, in TFTs that are fabricated on a glass substrate, the smaller they are made, the more variability there will be in their performance, which can reduce the reliability of a device that uses TFTs. Consequently, it is necessary to reduce the number of transistors that are provided in a pixel circuit in order to increase the reliability of the pixel circuit.

The present invention solves the problem described above, and the object thereof is to provide a pixel circuit that both reduces the number of transistors required to control an MEMS shutter, and reduces the time for writing to a transistor, and to provide a display device provided therewith.

### Means for Solving the Problem

One embodiment according to the present invention provides a pixel circuit comprising: a first capacitor, a first transistor, and a shutter portion; wherein one terminal of the first capacitor is connected to an actuating power supply, and the other terminal of the first capacitor is connected to one terminal of a first transistor and to a first shutter portion; and the other terminal of the first transistor is connected to a common electrode.

The pixel circuit may further comprise: a second capacitor, and a second transistor; wherein one terminal of the second transistor may be connected to a data line, and the other terminal of the second transistor is connected to one terminal of the second capacitor and to the gate of the first transistor; and the gate of the second transistor may be connected to a gate line and the other terminal of the second capacitor is connected to the common electrode.

In the pixel circuit, the shutter portion may have a first shutter member that has an opening portion, and a second shutter member and a third shutter member that allow the production of potential differences in relation to the first shutter member; the first shutter member may be connected to the other terminal of the first capacitor and to one terminal of the first transistor; and

the second shutter member may be connected to a first shutter power supply and the third shutter member may be connected to a second shutter power supply.

The pixel circuit may further comprise: a third capacitor, a third transistor, and an inverter circuit, wherein: the shutter portion may have a first shutter member that has an opening portion, and a second shutter member and a third shutter member that allow the production of potential differences in relation to the first shutter member; the first shutter member may be connected to a first shutter power supply; the second shutter member may be connected to the other terminal of the first capacitor and to one terminal of the first transistor; and one terminal of the third capacitor may be connected to an actuating power supply, and the other terminal of the third capacitor may be connected to one terminal of the third transistor and to the third shutter member; the other terminal of the third transistor may be connected to a common electrode; and the input terminal of the inverter circuit may be connected to the gate of the first transistor, and the output terminal of the inverter circuit may be connected to the gate of the third transistor.

In the pixel circuit has set forth in claim 4, the inverter circuit may be a CMOS; and the common gate of the CMOS may be connected to the gate of the first transistor, one terminal of the CMOS may be connected to the second shutter power supply, and the other terminal of the CMOS may be connected to a common electrode.

One embodiment according to the present invention provides a display device comprising: a plurality of pixels each disposed corresponding to an intersection between a plurality of data lines and a plurality of gate lines, disposed on a substrate; and a pixel circuit as set forth in any one of claim 1 through claim 5, disposed at the pixels.

In this display device: the shutter portion may have a first shutter member that has an opening portion, a second shutter member that has a first spring that is connected to a shutter and a first anchor that is connected to the first spring, a second spring that is connected to the shutter, and a second shutter member that is connected to the second spring; and the first spring and the second spring may be electrostatically driven by a potential difference between the first anchor and the second anchor.

In this display device an electropotential difference between the first anchor and the second anchor may be supplied by the pixel circuit.

This display device may further comprise: an opposing substrate that has a light transmitting portion, and that is bonded to the substrate; and a backlight that is disposed facing the opposing substrate; wherein: light that is supplied from the backlight may pass through a part wherein an opening portion of the first shutter member overlaps a light transmitting portion of the opposing substrate.

### Effects of the Invention

The present invention provides a pixel circuit that both reduces the number of transistors required to control an MEMS shutter, and reduces the time for writing to a transistor, and provides a display device provided therewith. This makes it possible to increase the level of resolution in an MEMS shutter display device.

### BRIEF DESCRIPTIONS OF THE DRAWINGS

FIG. 1 is a diagram illustrating a display device 10000 according to an embodiment according to the present invention, where (a) is a perspective diagram of the display device 10000 and (b) is a plan view diagram of the display device 10000.

FIG. 2 is a circuit block diagram of a display device according to an embodiment according to the present invention.

FIG. 3 is a schematic diagram of an MEMS shutter 1000 that is disposed corresponding to each pixel in the MEMS shutter display device 10000 according to an embodiment according to the present invention.

FIG. 4 is a circuit diagram illustrating a pixel circuit 100 according to the present invention.

FIG. 5 is a circuit diagram illustrating a pixel circuit 200 according to an embodiment according to the present invention.

FIG. 6 is a diagram showing a timing chart for driving a pixel circuit 200 according to the embodiment according to the present invention.

FIG. 7 is a diagram showing a timing chart for driving the pixel circuit 200 according to the embodiment according to the present invention.

FIG. 8 is a circuit diagram illustrating a pixel circuit 300 according to an embodiment according to the present invention.

FIG. 9 is a diagram showing a timing chart for driving a pixel circuit 300 according to the embodiment according to the present invention.

FIG. 10 is a diagram showing a timing chart for driving the pixel circuit 300 according to the embodiment according to the present invention.

FIG. 11 is a circuit diagram illustrating a pixel circuit 400 according to an embodiment according to the present invention.

FIG. 12 is a circuit diagram illustrating the pixel circuit 400 according to an embodiment according to the present invention.

FIG. 13 is a diagram showing a timing chart for driving the pixel circuit 400 according to the embodiment according to the present invention.

FIG. 14 is a diagram showing a timing chart for driving the pixel circuit 400 according to the embodiment according to the present invention.

FIG. 15 is a diagram showing a timing chart for driving the pixel circuit 500 according to the embodiment according to the present invention.

FIG. 16 is a diagram showing a timing chart for driving the pixel circuit 500 according to the embodiment according to the present invention.

FIG. 17 is a circuit diagram illustrating a conventional pixel circuit 800.

FIG. 18 is a circuit diagram illustrating a conventional pixel circuit 900.

### FORMS FOR CARRYING OUT THE INVENTION

The pixel circuit, and the device provided therewith, according to the present invention will be explained below in reference to the figures. Note that the pixel circuit, and the display device provided therewith, according to the present invention must not be interpreted as being limited to the detail set forth in the forms of embodiment and examples presented below. Note that in the drawings that reference the embodiments and examples, those parts that are identical or that have similar functions are assigned identical numerals, and repetitive explanations are omitted.

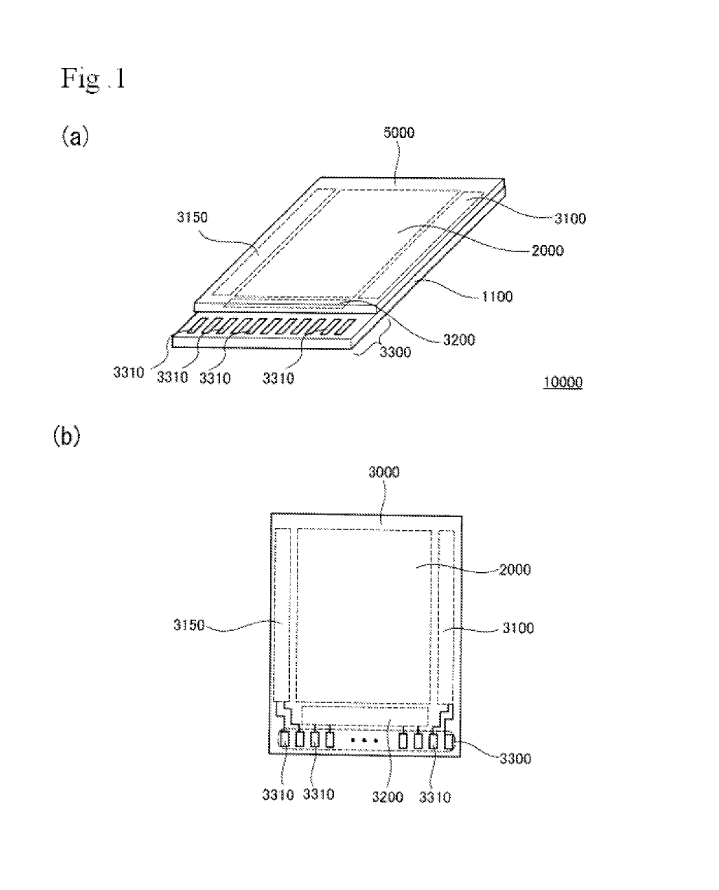

FIG. 1 is a diagram illustrating a display device 10000 according to an embodiment according to the present invention, where FIG. 1 (a) is a perspective diagram of the display device 10000 and FIG. 1 (b) is a plan view diagram of the display device 10000. The display device 10000 according to the present embodiment has a substrate 1100 and an opposing substrate 5000. The substrate 1100 has a display portion 2000, driving circuits 3100, 3150, and 3200, and a terminal portion 3300 wherein a plurality of terminals 3310 are arranged. The substrate 1100 and the opposing substrate 5000 are bonded using a seal material, or the like.

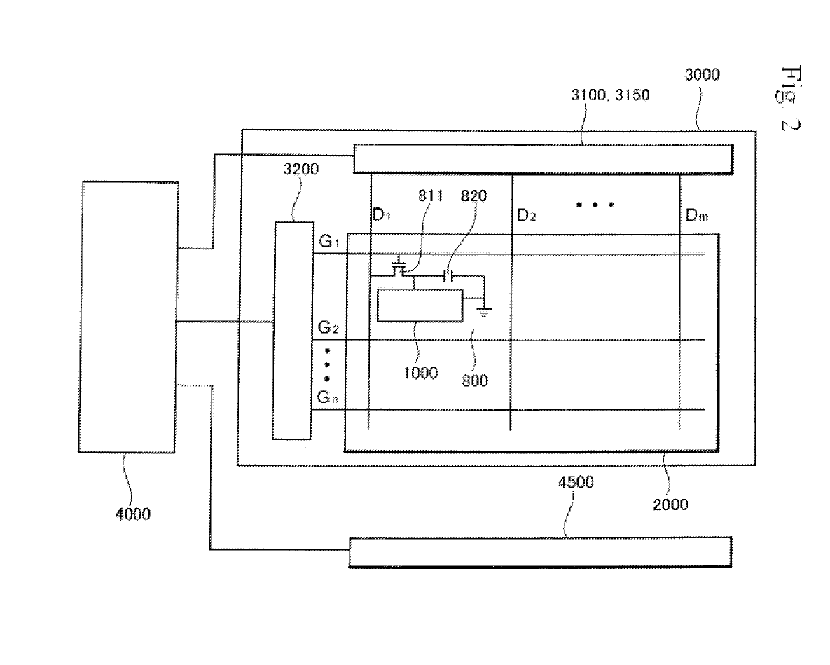

FIG. 2 is a circuit block diagram of a display device according to an embodiment according to the present invention. An image signal and a control signal are provided from a controller 4000 to the display device 10000 according to the embodiment according to the present invention illustrated in FIG. 2. Moreover, light from a backlight 4500 that is controlled by the controller 4000 is supplied to the display device 10000 according to the embodiment according to the present invention illustrated in FIG. 2. Note that the configuration may instead be one wherein the display device 10000 according to the present invention includes the controller 4000 and the backlight 4500.

While a display portion 2000 that has a conventional pixel circuit is illustrated in FIG. 2, the pixel circuit according to the present invention, described below, can be applied. The display portion 2000 has, at positions corresponding to the intersections between gate lines (G1, G2, . . . , Gn) and data lines (D1, D2, . . . , Dm), pixels (circuits) 800 having MEMS shutters 1000, which are arranged in a matrix, transistors (TFTs) 811, and capacitors 820. The driving circuits 3100 and 3150 are data drivers, and supply data signals through the data lines (D1, D2, . . . , Dm) to the transistors 811. The driving circuit 3200 is a gate driver, and provides gate signals through the data signal lines (G1, G2, . . . , Gn) to the transistors 811. Note that, as illustrated in FIG. 1, the driving circuits 3100 and 3150, which are the data drivers, are disposed so that the displaying portions 2000 are interposed therebetween in the present embodiment; however there is no limitation to this structure. The transistors 811 drive the MEMS shutters 1000 based on the data signals provided from the data lines (D1, D2, . . . , Dm).

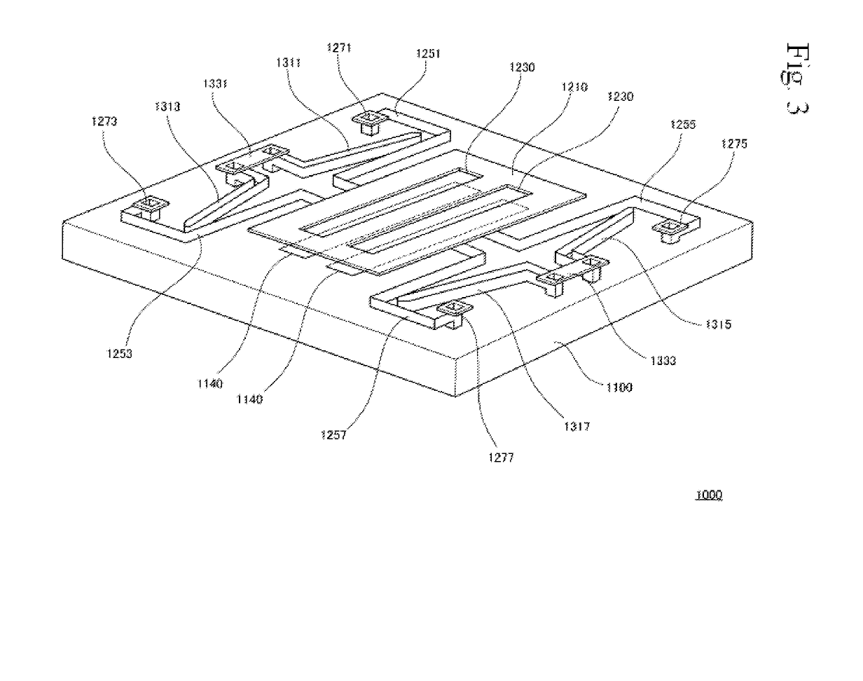

FIG. 3 is a schematic diagram of an MEMS shutter 1000 that is disposed corresponding to each pixel of the MEMS shutter display device 10000 according to the present embodiment. The MEMS shutter 1000 has a shutter 1210, first springs 1251, 1253, 1255, and 1257, second springs 1311, 1313, 1315, and 1317, an anchor portion 1271, 1273, 1275, and 1277. The shutter 1210 has one or more opening portions 1230, where the main body of the shutter 1210 is a light-blocking portion. Moreover, one or more light transmitting portions 1140 are formed on the substrate 1100. Moreover, in the display device the opposing substrate 5000, which has opening portions through which light can pass, is disposed facing the substrate 1100 whereon the shutters are arranged, where the opening portions of the opposing substrate 5000 and the light transmitting portions 1140 of the substrate 1100 are arranged so as to be essentially overlapping in the direction of the surface, and the opposing substrate is bonded to the substrate 1100 through a sealing material, or the like. The display device is structured so that the light that is provided from the back face of the opposing substrate 5000 and passes through an opening portion of the opposing substrate 5000 passes through the opening portion 1230 of a shutter 1210, and passes through a light transmitting portion 1140 of the substrate 1100, to be viewed by the human eye.

One side of the shutter 1210 is connected through first springs 1251 and 1253 to anchor portions 1271 and 1273. The anchor portions 1271 and 1273 have the function of supporting the shutter 1210, along with the first springs 1251 and 1253, suspended, away from the surface of the substrate. The anchor portion 1271 is connected electrically to the first spring 1251, and the anchor portion 1273 is connected electrically to the first spring 1253. The anchor portions 1271 and 1273 are supplied a bias electropotential, and the first springs 1251 and 1253 are supplied a bias electropotential, from transistors, as described below. Moreover, the other side of the shutter 1210 is connected through first springs 1255 and 1257 to anchor portions 1275 and 1277. The anchor portions 1275 and 1277 have the function of supporting the shutter 1210, along with the first springs 1255 and 1257, in a floating state, away from the surface of the substrate 1100. The anchor portion 1275 is connected electrically to the first spring 1255, and the anchor portion 1277 is connected electrically to the first spring 1257. The anchor portions 1275 and 1277 are provided a bias electropotential, and the first springs 1255 and 1257 are provided a bias electropotential, from transistors. A first shutter member is formed from the shutter 1210, the first springs 1251, 1253, 1255, and 1257, the anchor portions 1271 and 1273, and the anchor portions 1275 and 1277.

Moreover, second springs 1311 and 1313 are connected electrically to the anchor portion 1331. The anchor portion 1331 has the function of supporting the second springs 1311 and 1313 in a floating state, away from the surface of the substrate 1100. A ground electropotential is supplied to the anchor portion 1331, and a ground electropotential is supplied to the second springs 1311 and 1313. Note that the structure instead might be one wherein, instead of the aforementioned ground, a specific electropotential is supplied to the anchor portion 1331. (This is also true for the ground electropotentials in the explanation below.) Moreover, the second springs 1315 and 1317 are connected electrically to the anchor portion 1333. The anchor portion 1333 has the function of supporting, in a floating state, the second springs 1315 and 1317 away from the surface of the substrate 1100. The anchor portion 1333 and the second springs 1315 and 1317 are electrically connected. The ground electropotential is supplied to the anchor portion 1333, and the ground electropotential is the second springs 1315 and 1317. In the present embodiment, a second shutter member is formed from the second springs 1311 and 1313 and the anchor portion 1331. Moreover, a third shutter member is formed from the anchor portion 1333 and second springs 1315 and 1317.

As described above, in the present embodiment a bias electropotential is supplied to anchor portions 1271 and 1273, and a bias electropotential is supplied to the first springs 1251 and 1253, a ground potential is supplied to the anchor portion 1331, and a ground potential is supplied to the second springs 1311 and 1313, from transistors. The first spring 1251 and the second spring 1311 are electrostatically driven by the potential difference between the first springs 1251 and 1253 and the second springs 1311 and 1313, to move toward each other, and the first spring 1253 and the second spring 1313 are electrostatically driven, to move toward each other, thereby moving the shutter 1210. That is, the first shutter member moves toward the second shutter member side.

Moreover, similarly a bias electropotential is supplied to anchor portions 1275 and 1277, and a bias electropotential is supplied to the first springs 1255 and 1257, a ground potential is supplied to the anchor portion 1333, and a ground potential is supplied to the second springs 1315 and 1317, from transistors. The first spring 1255 and the second spring 1315 are electrostatically driven by the potential difference between the first springs 1257 and 1255 and the second springs 1317 and 1315, to move toward each other, and the first spring 1257 and the second spring 1317 are electrostatically driven, to move toward each other, thereby moving the shutter 1210. That is, the first shutter member moves toward the third shutter member side.

Driving the shutter 1210 using electrostatic force in this way enables the shutter 1210 to be operated at high speeds. Consequently, the display device 10000 can produce a gradation display through controlling the amount of light that passes through the opening portions 1230 by changing the positions of the shutters 1210 in a high-speed driving operation. Moreover, sequentially driving (through field-sequential driving) the light that is emitted from the backlight 4500 in a sequence of the three colors R, G, and B also makes it possible to produce a color display. In this case, the polarizing plate and the color filter that are required in a liquid crystal display device are unnecessary, making it possible to use the light from the backlight without attenuation.

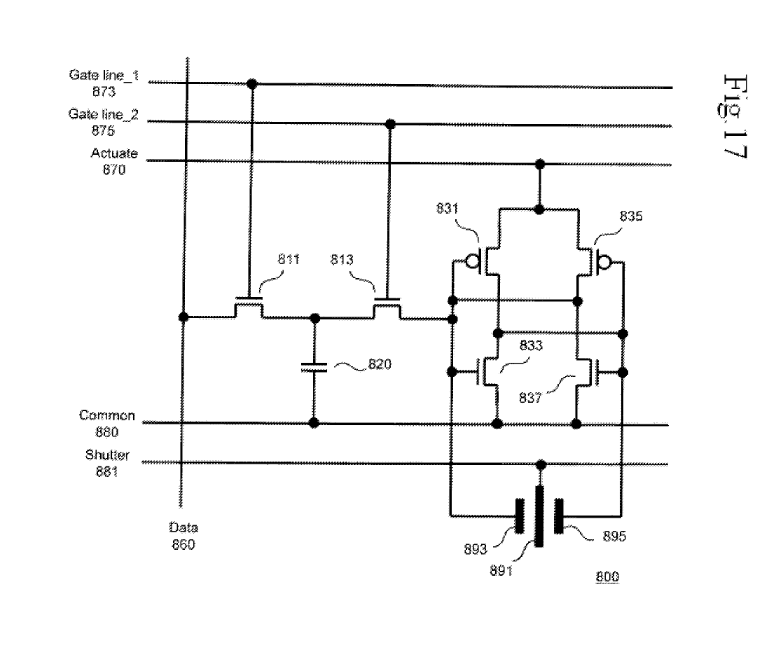

The pixel circuit for controlling the MEMS shutter 1000 will be explained next. FIG. 17 is a circuit diagram illustrating a conventional pixel circuit 800. In the pixel circuit 800, the two output terminals of the CMOS latch circuit (PMOS 831, NMOS 833, PMOS 835, and NMOS 837) are connected respectively to the second shutter member 893 and the third shutter member 895. One terminal of each of the PMOS 831 and the PMOS 835 is connected to the actuating power supply (Actuate) 870 and one terminal each of the NMOS 833 and the NMOS 837 is connected to the common power supply (Common) 880. 25 V, for example, is supplied to the actuating power supply 870 and the common power supply 880 is grounded. Moreover, the first shutter member 891 is connected to a shutter power supply (Shutter) 881 and is supplied, for example, 25 V.

Moreover, in order to control the CMOS latch circuit, a terminal of the two transistors (NMOS 811 and NMOS 813), which are connected in series, is connected to the gates of PMOS 831 and NMOS 833. A capacitor 820 is connected to the connecting portion between NMOS 811 and NMOS 813, where one terminal of the capacitor 820 is connected to the common power supply 880. One terminal of the NMOS 811 is connected to a data line (Data) 860, to be supplied with two different electropotentials of, for example, 5 V and 0 V. Furthermore, the gate of the NMOS 811 is connected to a gate line (Gate line_{—}1) 873, and the gate of the NMOS 813 is connected to a gate line (Gate line_{—}2) 875. The gate line 873 and the gate line 875 provide two different electropotentials, of 5 V and 0 V.

In the pixel circuit 800, a CMOS latch circuit is controlled by two transistors (the NMOS 811 and the NMOS 813) and one capacitor 820, to cause the first shutter member 891 to move, through producing an electropotential difference by supplying mutually differing electropotentials, such as, for example, 25 V or 0 V, to the second shutter member 893 and the third shutter member 895. However, as is clear from FIG. 17, because the conventional pixel circuit 800 is formed from six transistors, the number of transistors that are included in the display device as a whole is large.

While typically a glass substrate is used for the substrate 1100 in an MEMS display device, there is a tendency for there to be large variability in the threshold voltages among the transistors (TFTs) that are formed on a glass substrate. When, as a result, there is variability in the performance of the transistors that are formed on the glass substrates, there will be pixel defects, in which the pixel circuits are not actuated at the intended electropotential. Moreover, these transistors must be disposed on the outside of the region where the shutter members are disposed, so when the size of the pixel is reduced, the transistors that are required for forming the pixel circuit cannot be accommodated within that size. On the other hand, the capacitors can be disposed even under the shutter members, and so when compared to the transistors, the issues involved in increasing the level of resolution are not so large. Consequently, reducing the number of transistors included in a pixel circuit is useful in order to raise the level of resolution of an MEMS display device.

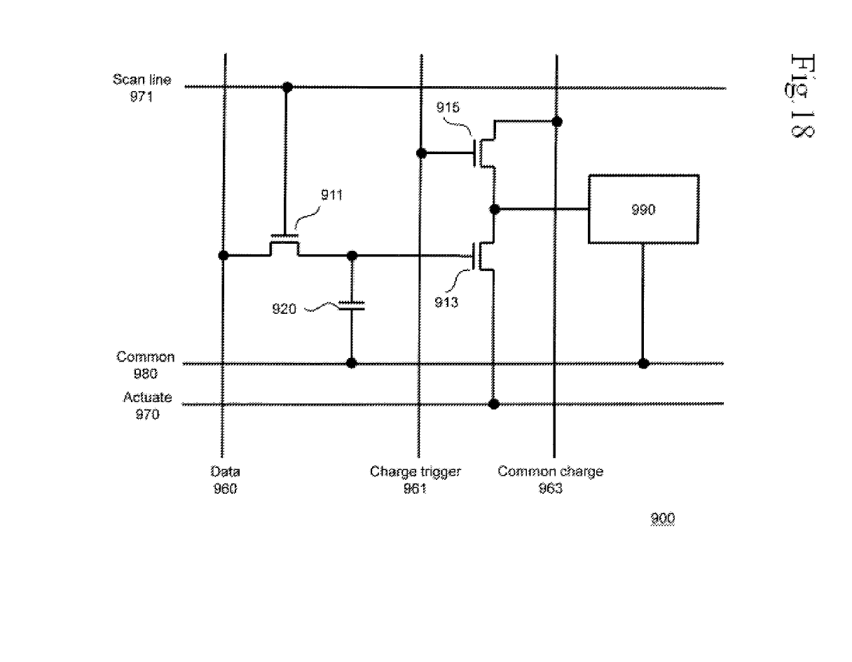

On the other hand, the pixel circuit 900 illustrated in FIG. 18 is a circuit wherein the shutter is controlled without the use of a CMOS latch circuit. In the pixel circuit 900 the shutter portion 990 is controlled by a circuit structured from three transistors (an NMOS 911, an NMOS 913, and an NMOS 915) and one capacitor 920. One terminal of the NMOS 911 is connected to a data line 960 and the other terminal is connected to one terminal of the capacitor 920 and the gate of the NMOS 913. The other terminal of the NMOS 913 is connected to one terminal of the NMOS 915 and the shutter portion 990. Moreover, the gate of the NMOS 911 is connected to a scan line 971, where the other terminal of the capacitor 920 is connected to a common power supply 980. The gate of the NMOS 915 is connected to a charge trigger 961, where the other terminal is connected to a common charge 963.

In the pixel circuit 900 the number of transistors required in the circuit structure is less than that required for the pixel circuit 800, where, at first glance, one may think that this would be useful in increasing the resolution of an MEMS display device. However, in the pixel circuit 900, at best two motions are required in order to secure the position of the shutter. For example, even when moving the first shutter member to the second shutter member side, it is necessary to move to the second shutter member side after first moving to the third shutter member side. Given the above, the time required for writing to a pixel is twice that in the pixel circuit 800, and thus it is necessary to increase the speed further.

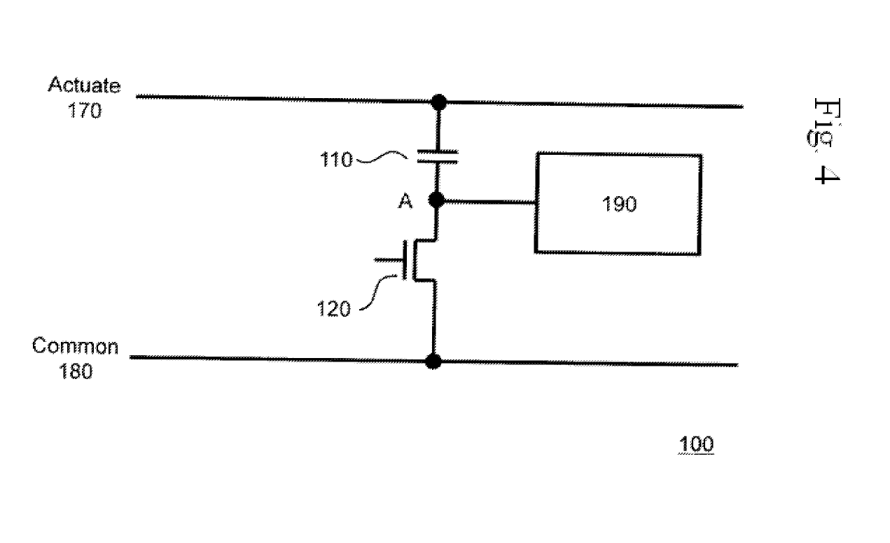

The present inventors, as the result of earnest investigations, discovered a pixel circuit wherein the two requirements, that is, increasing the speed of writing to the pixel and the reduction in the number of transistors, are fulfilled simultaneously. FIG. 4 is a circuit diagram illustrating a pixel circuit 100 according to the present invention. The pixel circuit 100 is provided with a capacitor 110 and a transistor 120 connected in series, and a shutter portion 190. One terminal of the capacitor 110 is connected to an actuating power supply (Actuate) 170, the other terminal is connected to one terminal of the transistor 120 and the shutter portion 190, and the other terminal of the transistor 120 is connected to a common electrode (Common) 180. Additionally, the gate of the transistor 120 can be controlled by the voltage applied from a data line (not shown). The actuating power supply 170 is supplied with, for example, 25 V or 0 V, and the common electrode 180 is grounded.

When explaining the operation of the pixel circuit 100, here, when a high-voltage is supplied to the actuating power supply 170 in a state wherein the transistor 120 is closed, the electropotential thereof is held in the capacitor 110. The stored electropotential is supplied to the shutter portion 190. When the transistor 120 is opened, the electropotential that is stored in the capacitor 110 flows to the common electrode 180, so the electropotential at point A goes to the low electropotential (for example, 0 V), and the electropotential that is supplied to the shutter portion 190 also goes to the low electropotential. In this way, the pixel circuit 100, through controlling the transistor 120, is able to control the electropotential that is supplied to the shutter portion 190. Note that while the transistor 120 is illustrated as an NMOS in FIG. 4, the transistor 120 may instead be a PMOS, in which case switching may be performed by applying to the gate an electropotential that is the opposite of that in the case of NMOS. The pixel circuit in the present invention will be explained using more detailed embodiments.

### First Embodiment

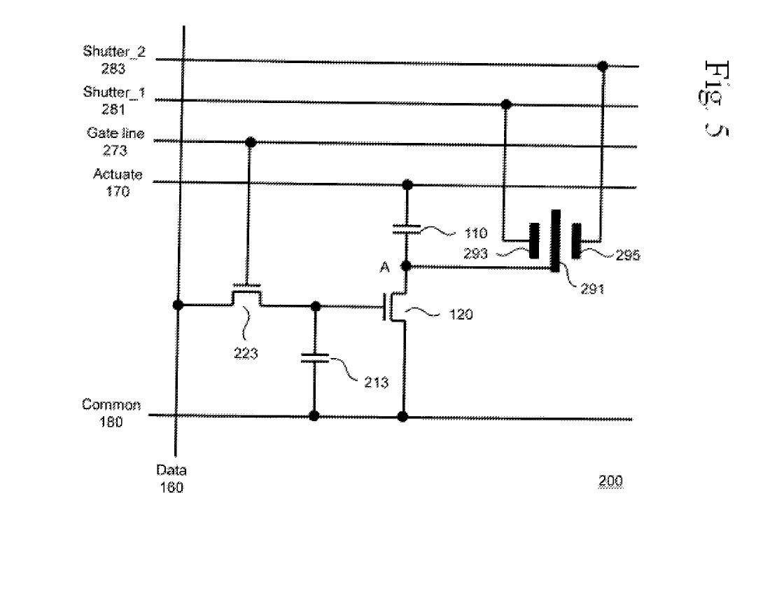

FIG. 5 is a circuit diagram illustrating a pixel circuit 200 according to an embodiment according to the present invention. The pixel circuit 200 is provided with a first capacitor 110, a first transistor (NMOS) 120, and a shutter portion, where one terminal of the capacitor 110 is connected to an actuating power supply (Actuate) 170, the other terminal of the capacitor 110 is connected to one terminal of the NMOS 120 and to the shutter portion, and the other terminal of the NMOS 120 is connected to the common electrode (Common) 180. Moreover, the pixel circuit 200 is provided further with a second capacitor 213 and a second transistor (NMOS) 223, where one terminal of the NMOS 223 is connected to a data line (Data) 160, the other terminal of the NMOS 223 is connected to one terminal of the capacitor 213 and the gate of the NMOS 120, the gate of the NMOS 223 is connected to a gate line (Gate line) 273, and the other terminal of the capacitor 213 is connected to the common electrode 180.

Moreover, in the pixel circuit 200, the shutter portion has a first shutter member 291 that has an opening portion, and a second shutter member 293 and third shutter member 295 that allow the production of an electropotential difference relative to the first shutter member 291, where the first shutter member 291 is connected to the other terminal of the capacitor 110 and one terminal of the NMOS 120, the second shutter member 293 is connected to a first shutter power supply (Shutter_{—}1) 281, and the third shutter member 295 is connected to the second shutter power supply (Shutter_{—}2) 283. The pixel circuit 200 according to an embodiment according to the present invention is able to control the shutter using two transistors and two capacitors.

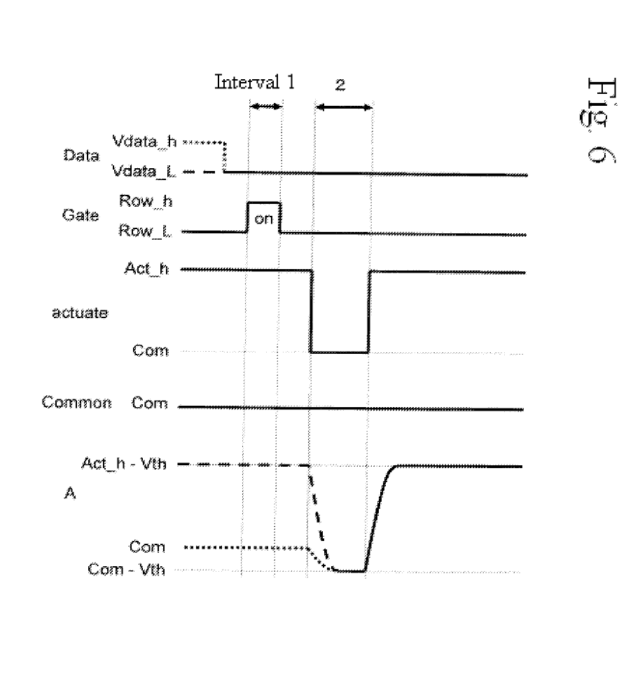

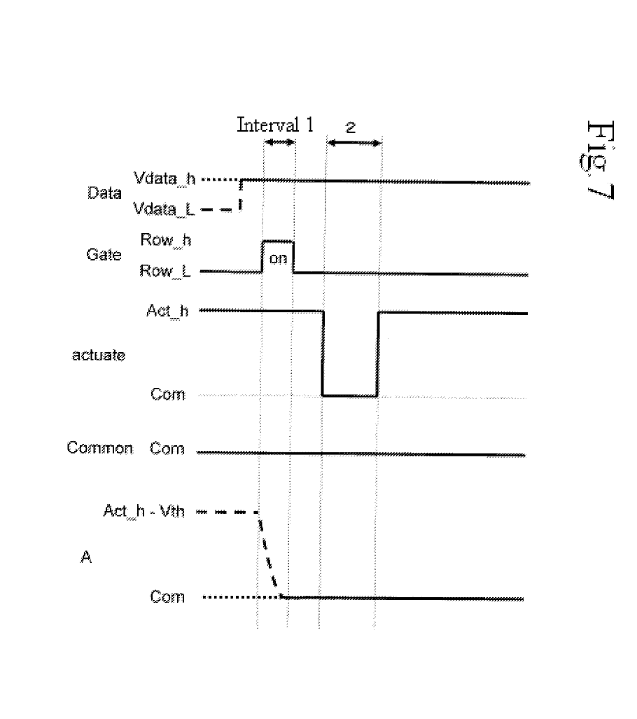

The control method for the shutter using the pixel circuit 200 will be explained next using FIG. 6 and FIG. 7. FIG. 6 is a diagram showing a timing chart for driving the pixel circuit 200 according to one embodiment according to the present invention. FIG. 6 shows the case when writing a low electropotential (Vdata_L) as the data voltage. The Vdata_L is the electropotential when the NMOS 120 is turned OFF, and, for example, is 0 V, along with the common electropotential (Com). Over an interval 1, the NMOS 223 is turned ON by the gate line 273, and the data voltage is stored in the capacitor 213. At this time, the data voltage is Vdata_L, and thus the NMOS 120 is in the OFF state. Thereafter, during an interval 2, the actuating power supply 170 falls to the Com electropotential. At this time, the electropotential at point A in FIG. 5 converges to Com−Vth (the threshold value for the NMOS 120) regardless of what the electropotential of point A was during interval 1 and before. Thereafter, the actuating power supply 170 is raised to the high electropotential (Act_h). Because the NMOS 120 is in the OFF state, the electropotential at point A converges to Act_h−Vth, following the electropotential of the actuating power supply 170. Consequently, if Vdata_L is written as the data voltage, then the electropotential of the first shutter member 291 will converge to Act_h−Vth.

FIG. 7 is a diagram showing a timing chart for driving the pixel circuit 200 according to one embodiment according to the present invention. FIG. 7 shows the case when writing the high electropotential (Vdata_h) as the data voltage. The Vdata_h is the electropotential with which the NMOS 223 is turned ON, for example 5 V. Over an interval 1, the NMOS 223 is turned ON by the gate line 273, and the data voltage is stored in the capacitor 213. Because, at this time, the NMOS 120 is in the ON state, the electropotential at point A in FIG. 5 converges to Corn, regardless of what the electropotential of point A was during interval 1 and before. Thereafter, even if the voltage of the actuating power supply 170 were to change during interval 2, the NMOS 223 would remain in the ON state, and point A in FIG. 5 would remain at the Com electropotential. Consequently, if Vdata_h is written as the data voltage, then the electropotential of the first shutter member 291 will converge to Com.

As explained above, the pixel circuit according to the present embodiment has the superior effect of being able to control a shutter through a circuit that uses two transistors and two capacitors, which is smaller than the conventional circuit, and also of being able to achieve positioning and securing of the shutter in a single shutter motion (one motion). Consequently, the pixel circuit according to the present embodiment enables an increase in resolution in a display device.

### Second Embodiment

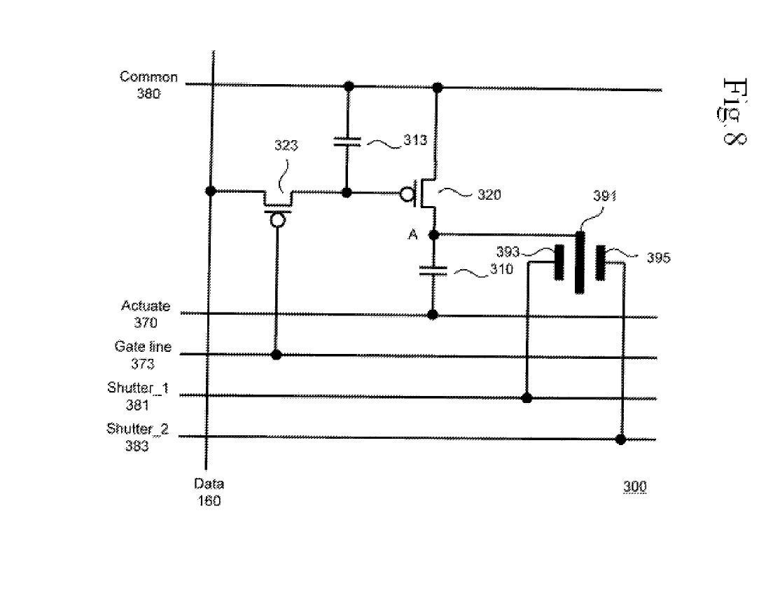

A pixel circuit 300 is illustrated in FIG. 8 as a second embodiment. Aside from replacing the NMOS in the pixel circuit 200 with the PMOS, the pixel circuit 300 is configured identically to the pixel circuit 200. The pixel circuit 300 is provided with a first capacitor 310, a first transistor (PMOS) 320, and a shutter portion, where one terminal of the capacitor 310 is connected to an actuating power supply (Actuate) 370, the other terminal of the capacitor 310 is connected to one terminal of the PMOS 320 and to the shutter portion, and the other terminal of the PMOS 320 is connected to the common electrode (Common) 380. Moreover, the pixel circuit 300 is provided further with a second capacitor 313 and a second transistor (PMOS) 323, where one terminal of the PMOS 323 is connected to a data line (Data) 360, the other terminal of the PMOS 323 is connected to one terminal of the capacitor 313 and the gate of the PMOS 320, the gate of the PMOS 323 is connected to a gate line (Gate line) 373, and the other terminal of the capacitor 313 is connected to the common terminal 380.

Moreover, in the pixel circuit 300, the shutter portion has a first shutter member 391 that has an opening portion, and a second shutter member 393 and third shutter member 394 that allow the production of an electropotential difference in relation to the first shutter member 391, where the first shutter member 391 is connected to the other terminal of the capacitor 310 and one terminal of the PMOS 320, the second shutter member 393 is connected to a first shutter power supply (Shutter_{—}1) 381, and the third shutter member 395 is connected to the second shutter power supply (Shutter_{—}2) 383. The pixel circuit 300 according to the embodiment according to the present invention is able to control the shutter using two transistors and two capacitors.

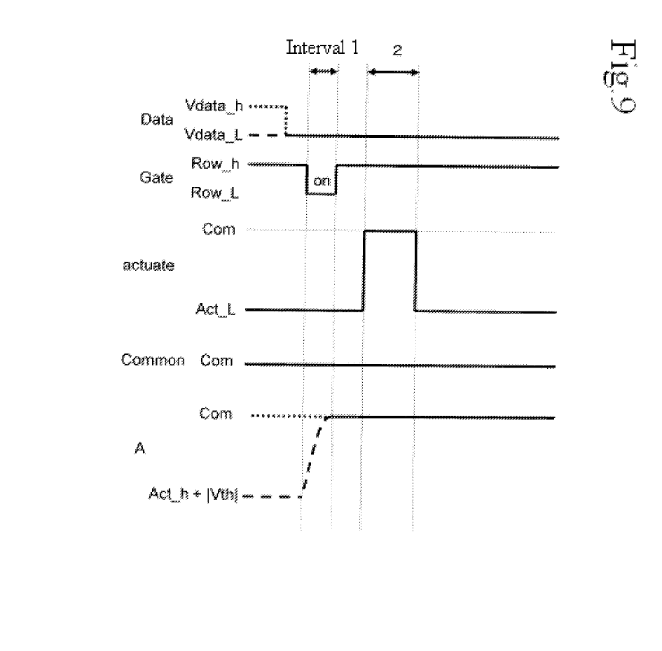

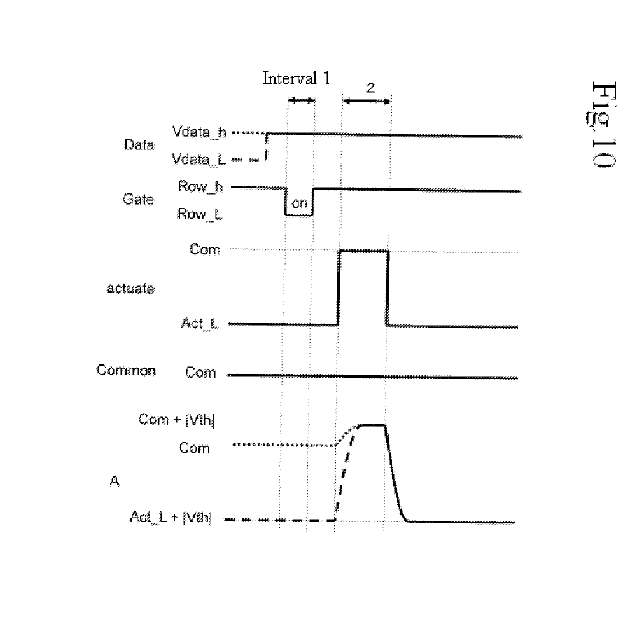

The control method for the shutter using the pixel circuit 300 will be explained next using FIG. 9 and FIG. 10. FIG. 9 is a diagram showing a timing chart for driving the pixel circuit 300 according to one embodiment according to the present invention. FIG. 9 shows the case when writing a low electropotential (Vdata_L) as the data voltage. The Vdata_L is the electropotential for which the PMOS 320 is turned OFF, and, for example, is 0 V, along with the common electropotential (Com). Over an interval 1, the PMOS 323 is turned ON by the gate line 373, and the data voltage is stored in the capacitor 313. At this time, the data voltage is Vdata_L, and thus the NMOS 320 is in the ON state. Thereafter, during an interval 2, the actuating power supply 370 rises to the Com electropotential. At this time, the electropotential at point A in FIG. 8 converges to Com (the threshold value for the NMOS 320) regardless of what the electropotential of point A was during interval 1 and before. Consequently, if Vdata_L is written as the data voltage, then the electropotential of the first shutter member 391 will converge to Com.

FIG. 10 is a diagram showing a timing chart for driving the pixel circuit 300 according to one embodiment according to the present invention. FIG. 10 shows the case when writing the high electropotential (Vdata_h) as the data voltage. The Vdata_h is the electropotential for which the PMOS 323 is turned OFF, for example 5 V. Over an interval 1, the PMOS 320 is turned ON by the gate line 373, and the data voltage is stored in the capacitor 313. Because, at this time, the PMOS 323 is in the OFF state, the electropotential at point A in FIG. 8 converges to Act_L+|Vth|, regardless of what the electropotential of point A was during interval 1 and before. Thereafter, if the voltage of the actuating power supply 370 were to change during interval 2, the PMOS 323 would remain in the OFF state, and point A in FIG. 8 would go to the Com electropotential. Thereafter, the actuating power supply 370 is lowered to the high electropotential (Act_L). Because the PMOS 320 is in the OFF state, the electropotential at point A converges to Act_L+|Vth|, following the electropotential of the actuating power supply 370. Consequently, if Vdata_h is written as the data voltage, then the electropotential of the first shutter member 391 will converge to Com.

As explained above, the pixel circuit according to the present embodiment has the superior effect of being able to control a shutter through a circuit that uses two transistors and two capacitors, which is smaller than the conventional circuit, and also of being able to achieve positioning and securing of the shutter in a single shutter motion (one motion). Consequently, the pixel circuit according to the present embodiment enables an increase in resolution in a display device.

### Third Embodiment

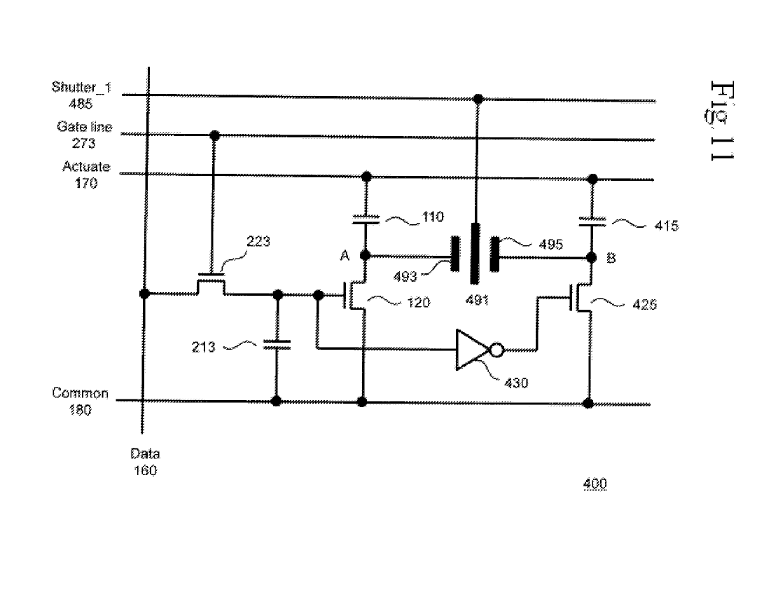

In the first and second embodiments, examples were shown wherein the electropotential of a first shutter member was controlled by a circuit that used two transistors and two capacitors. In the present embodiment, and example will be explained wherein the electropotential of a second shutter member and of a third shutter member is controlled. FIG. 11 is a circuit diagram illustrating a pixel circuit 400 according to an embodiment according to the present invention. The pixel circuit 400 is provided with a first capacitor 110, a first transistor (NMOS) 120, and a shutter portion, where one terminal of the capacitor 110 is connected to an actuating power supply (Actuate) 170, the other terminal of the capacitor 110 is connected to one terminal of the NMOS 120 and to the shutter portion, and the other terminal of the NMOS 120 is connected to the common electrode (Common) 180. Moreover, the pixel circuit 400 is provided further with a second capacitor 213 and a second transistor (NMOS) 223, where one terminal of the NMOS 223 is connected to a data line (Data) 160, the other terminal of the NMOS 223 is connected to one terminal of the capacitor 213 and the gate of the NMOS 120, the gate of the NMOS 223 is connected to a gate line (Gate line) 273, and the other terminal of the capacitor 213 is connected to the common terminal 180.

The pixel circuit 400 further comprises a third capacitor 415, a third transistor (NMOS) 425, and an inverter circuit 430. Moreover, the shutter portion has a first shutter member 491 that has an opening portion, and a second shutter member 493 and a third shutter member 495 that allow the production of potential differences in relation to the first shutter member 491. The first shutter member 491 is connected to a first shutter power supply (Shutter_{—}1) 485, the second shutter member 493 is connected to the other terminal of the capacitor 110 and one terminal of the NMOS 120, where one terminal of the capacitor 415 is connected to the actuating power supply 170, the other terminal of the capacitor 415 is connected to one terminal of the NMOS 425 and the third shutter member 495, the other terminal of the NMOS 425 is connected to the common electrode 180, the input terminal of the inverter circuit 430 is connected to the gate of the NMOS 120, and the output terminal of the inverter circuit 430 is connected to the gate of the NMOS 425.

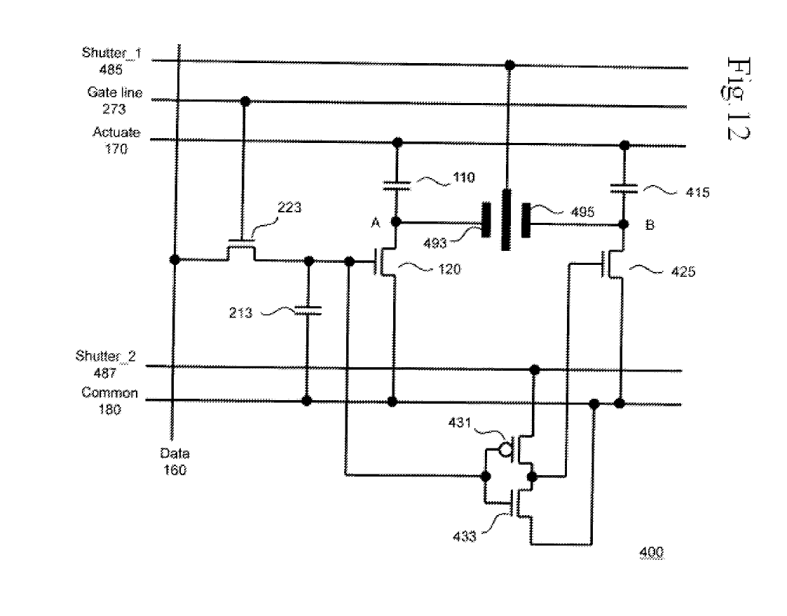

FIG. 12 is a circuit diagram of the pixel circuit 400 that uses a CMOS as the inverter circuit 430. The inverter circuit 430 is formed from a PMOS 431 and an NMOS 433, connected in series, and, as described above, the common gate of the PMOS 431 and the NMOS 433 is connected to the gate of the NMOS 120. Moreover, one terminal of the PMOS 431 is connected to a second shutter power supply (Shutter_{—}2) 487, and one terminal of the NMOS 433 is connected to a common electrode 180. The pixel circuit 400 according to the present embodiment according to the present invention enables control of the shutter using five transistors and three capacitors. When compared to the conventional pixel circuit 800, the number of transistors has been reduced by only one, but because, for the display device as a whole, this is a substantial reduction, it is able to provide display devices with improved reliability.

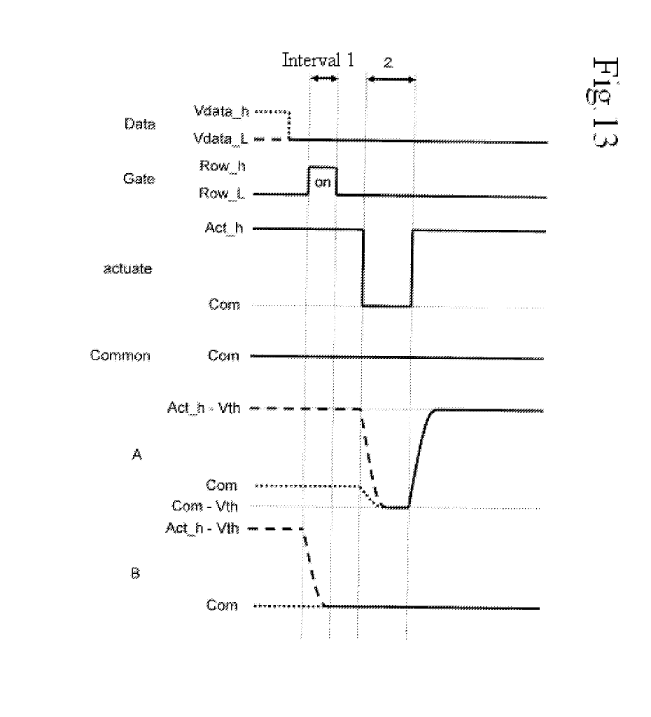

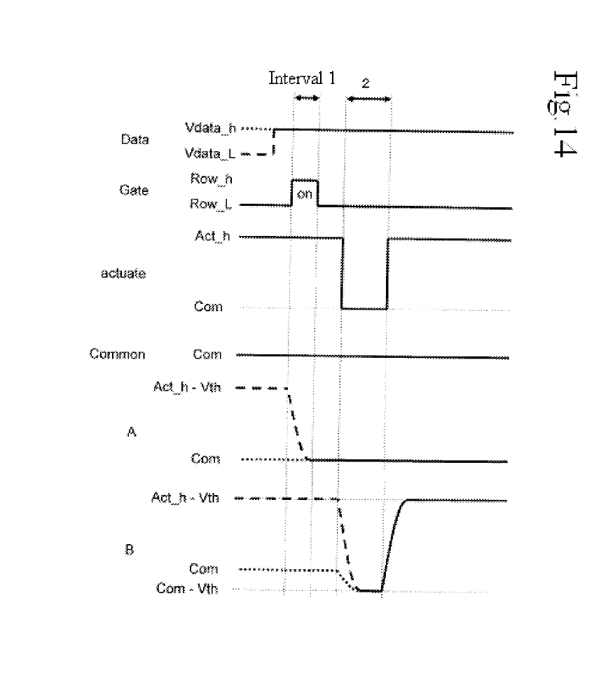

The control method for the shutter using the pixel circuit 400 will be explained next using FIG. 13 and FIG. 14. FIG. 13 is a diagram showing a timing chart for driving the pixel circuit 400 according to one embodiment according to the present invention. FIG. 13 shows the case when writing a low electropotential (Vdata_L) as the data voltage. The Vdata_L is the electropotential with which the NMOS 120 is turned OFF, and, for example, is 0 V, along with the common electropotential (Com). Over an interval 1, the NMOS 223 is turned ON by the gate line 273, and the data voltage is stored in the capacitor 213. At this time, the data voltage is Vdata_L, and thus the NMOS 120 is in the OFF state, and thus the electropotential of point A in FIG. 12 remains at Act_h−Vth. On the other hand, the PMOS 431 goes into the ON state and the NMOS 433 goes into the OFF state, and thus the gate of the NMOS 425 rises to the high electropotential, turning it ON, so the electropotential at the point B in FIG. 12 falls from the actuating power supply 170 to the Com electropotential.

Thereafter, during an interval 2, the actuating power supply 170 falls to the Com electropotential. At this time, the electropotential at point A in FIG. 12 converges to Com−Vth (the threshold value for the NMOS 120) regardless of what the electropotential of point A was during interval 1 and before. Thereafter, the actuating power supply 170 is raised to the high electropotential (Act_h). Because the NMOS 120 is in the OFF state, the electropotential at point A converges to Act_h−Vth, following the electropotential of the actuating power supply 170. On the other hand, the electropotential of point B remains at the Com electropotential. Consequently, if Vdata_L is written as the data voltage, then the electropotential of the second shutter member 493 will converge to Act_h−Vth, and the electropotential of the third shutter member 495 will converge to the Com electropotential.

FIG. 14 is a diagram showing a timing chart for driving the pixel circuit 400 according to one embodiment according to the present invention. FIG. 14 is the case when writing the high electropotential (Vdata_h) as the data voltage. The Vdata_h is the electropotential with which the NMOS 223 is turned ON, for example 5 V. Over an interval 1, the NMOS 223 is turned ON by the gate line 273, and the data voltage is stored in the capacitor 213. Because, at this time, the NMOS 120 is in the ON state, the electropotential at point A in FIG. 12 converges to Com, regardless of what the electropotential of point A was during interval 1 and before. On the other hand, the PMOS 431 goes into the OFF state and the NMOS 433 goes into the ON state, and thus the gate of the NMOS 425 falls to the low electropotential and thus it remains in the OFF state, so the electropotential at the point B in FIG. 12 remains at the Act_Vth of the actuating power supply 170.

Thereafter, the actuating power supply 170 falls to the Com electropotential. The NMOS 223 remains in the ON state, and point A in FIG. 12 remains at the Com electropotential. On the other hand, the electropotential at point B in FIG. 12 converges to Com−Vth, following the electropotential of the actuating power supply 170. Thereafter, the actuating power supply 170 is raised to the high electropotential (Act_h). The NMOS 120 remains in the ON state, and point A remains at the Com electropotential. On the other hand, the electropotential at point B converges to Act−Vth, following the electropotential of the actuating power supply 170. Consequently, if Vdata_h is written as the data voltage, then the electropotential of the second shutter member 493 will converge to Com, and the electropotential of the third shutter member 495 will converge to the Act_h−Vth electropotential.

As explained above with the pixel circuit according to the present embodiment, for controlling the shutter using five transistors and three capacitors, the number of transistors has been reduced by only one, when compared to the conventional pixel circuit, but because, for the display device as a whole, this is a substantial reduction, it is able to provide display devices with improved reliability. Moreover, it has the superior effect of being able to achieve positioning and securing of the shutter in a single shutter motion (one motion). Consequently, the pixel circuit according to the present embodiment enables an increase in resolution in a display device.

### Fourth Embodiment

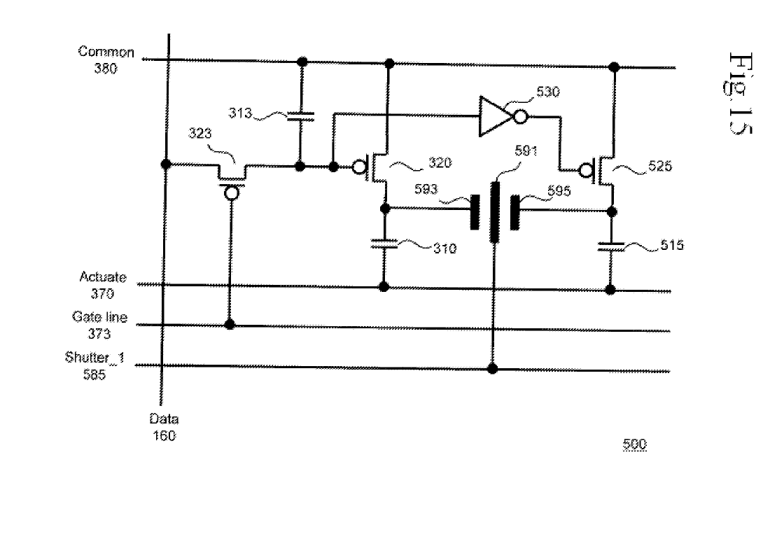

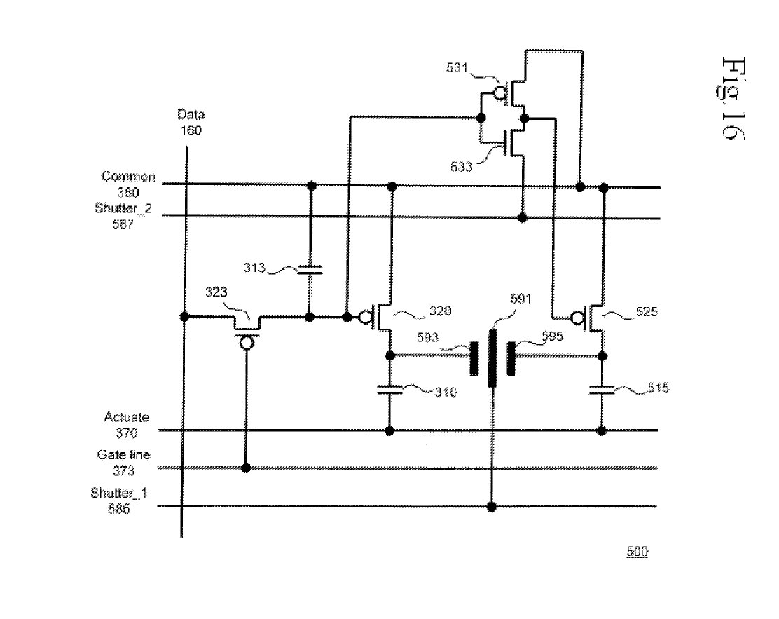

A pixel circuit 500 is illustrated in FIG. 15 and FIG. 16 as a fourth embodiment. Aside from replacing the NMOS in the pixel circuit 400 with the PMOS, the pixel circuit 500 is configured identically to the pixel circuit 400. FIG. 15 is a circuit diagram illustrating a pixel circuit 500 according to an embodiment according to the present invention. The pixel circuit 500 is provided with a first capacitor 310, a first transistor (PMOS) 320, and a shutter portion, where one terminal of the capacitor 310 is connected to an actuating power supply (Actuate) 370, the other terminal of the capacitor 310 is connected to one terminal of the PMOS 320 and to the shutter portion, and the other terminal of the PMOS 320 is connected to the common electrode (Common) 380. Moreover, the pixel circuit 500 is provided further with a second capacitor 313 and a second transistor (PMOS) 323, where one terminal of the PMOS 323 is connected to a data line (Data) 160, the other terminal of the PMOS 3223 is connected to one terminal of the capacitor 313 and the gate of the PMOS 320, the gate of the PMOS 323 is connected to a gate line (Gate line) 373, and the other terminal of the capacitor 313 is connected to the common terminal 380.

The pixel circuit 500 further comprises a third capacitor 515, a third transistor (PMOS) 525, and an inverter circuit 530. Moreover, the shutter portion has a first shutter member 591 that has an opening portion, and a second shutter member 591 and a third shutter member 593 that allow the production of potential differences in relation to the first shutter member 595. The first shutter member 591 is connected to a first shutter power supply (Shutter_{—}1) 585, the second shutter member 593 is connected to the other terminal of the capacitor 310 and one terminal of the PMOS 320, where one terminal of the capacitor 515 is connected to the actuating power supply 370, the other terminal of the capacitor 515 is connected to one terminal of the PMOS 525 and the third shutter member 595, the other terminal of the PMOS 525 is connected to the common electrode 380, the input terminal of the inverter circuit 530 is connected to the gate of the PMOS 320, and the output terminal of the inverter circuit 530 is connected to the gate of the PMOS 525.

FIG. 16 is a circuit diagram of the pixel circuit 500, using a CMOS as the inverter circuit 530. The inverter circuit 530 is formed from a PMOS 531 and an NMOS 533, connected in series, and, as described above, the common gate of the PMOS 531 and the NMOS 533 is connected to the gate of the PMOS 320. Moreover, one terminal of the NMOS 533 is connected to a second shutter power supply (Shutter_{—}2) 587, and one terminal of the PMOS 531 is connected to a common electrode 380.

Note that the control method for the shutter using the pixel circuit 500 is the same as that in the pixel circuit 400, so detailed explanations will be omitted. With the pixel circuit according to the present embodiment, for controlling the shutter using five transistors and three capacitors, the number of transistors has been reduced by only one, when compared to the conventional pixel circuit, but because, for the display device as a whole, this is a substantial reduction, it is able to provide display devices with improved reliability. Moreover, it has the superior effect of being able to achieve positioning and securing of the shutter in a single shutter motion (one motion). Consequently, the pixel circuit according to the present embodiment enables an increase in resolution in a display device.
100: Pixel Circuit
110: Capacitor
120: Transistor (NMOS)
160: Data Line
170: Actuating Power Supply
180: Common Electrode
190: Shutter Portion
200: Pixel Circuit
213: Second Capacitor
223: NMOS
273: Gate Line
280: First Shutter Power Supply
283: Second Shutter Power Supply
291: First Shutter Member
293: Second Shutter Member
295: Third Shutter Member
300: Pixel Circuit
310: First Capacitor
313: Capacitor
320: PMOS
323: PMOS
370: Actuating Power Supply
380: Common Electrode
360: Data Line
373: Gate Line
380: Common Electrode
381: First Shutter Power Supply
383: Second Shutter Power Supply
391: First Shutter Member
393: Second Shutter Member
395: Third Shutter Member
400: Pixel Circuit
415: Third Capacitor
425: NMOS
430: Inverter Circuit
431: PMOS
433: NMOS
485: First Shutter Power Supply
487: Second Shutter Power Supply
491: First Shutter Member
493: Second Shutter Member
495: Third Shutter Member
500: Pixel Circuit
515: Third Capacitor
525: PMOS
530: Inverter Circuit
531: PMOS
533: NMOS
585: First Shutter Power Supply
587: Second Shutter Power Supply
591: First Shutter Member
593: Second Shutter Member
595: Third Shutter Member
800: Pixel Circuit
811: NMOS
813: NMOS
820: Capacitor
831: PMOS
833: NMOS
835: PMOS
837: NMOS
860: Data Line
870: Actuating Power Supply
873: Gate Line
875: Gate Line
880: Common Power Supply
881: Shutter Power Supply
889: First Shutter Member
893: Second Shutter Member
895: Third Shutter Member
900: Pixel Circuit
990: Shutter Portion
911: NMOS
913: NMOS
915: NMOS
920: Capacitor
960: Data Line
961: Charge Trigger
963: Common Charge
971: Scan Line
918: Common Electrode
990: Shutter Portion
1000: MEMS Shutter
1100: Substrate
1140: Optical Transmissive Portion
1210: Shutter
1230: Opening Portion
1251: First Spring
1253: First Spring
1255: First Spring
1257: First Spring
1311: Second Spring
1313: Second Spring
1315: Second Spring
1317: Second Spring
1271: Anchor Portion
1273: Anchor Portion
1275: Anchor Portion
1277: Anchor Portion
1331: Anchor Portion
1333: Anchor Portion
2000: Display Portion
3100: Driving Circuit
3150: Driving Circuit
3200: Driving Circuit
3310: Terminal
3300: Terminal Portion
4000: Controller
4500: Backlight
5000: Opposing Substrate
10000: Display Device

1. A pixel circuit comprising:
a first capacitor, a first transistor, and a shutter portion; wherein
one terminal of the first capacitor is connected to an actuating power supply, and the other terminal of the first capacitor is connected to one terminal of a first transistor and to a first shutter portion; and the other terminal of the first transistor is connected to a common electrode.

2. A pixel circuit as set forth in claim 1, further comprising:
a second capacitor, and a second transistor; wherein
one terminal of the second transistor is connected to a data line, and the other terminal of the second transistor is connected to one terminal of the second capacitor and to a gate of the first transistor; and
a gate of the second transistor is connected to a gate line and the other terminal of the second capacitor is connected to the common electrode.

3. A pixel circuit as set forth in claim 2, wherein:
the shutter portion has a first shutter member that has an opening portion, and a second shutter member and a third shutter member that allow the production of potential differences in relation to the first shutter member;
the first shutter member is connected to the other terminal of the first capacitor and to one terminal of the first transistor; and
the second shutter member is connected to a first shutter power supply and the third shutter member is connected to a second shutter power supply.

4. A pixel circuit as set forth in claim 2, further comprising:
a third capacitor, a third transistor, and an inverter circuit, wherein:
the shutter portion has a first shutter member that has an opening portion, and a second shutter member and a third shutter member that allow the production of potential differences in relation to the first shutter member;
the first shutter member is connected to a first shutter power supply;
the second shutter member is connected to the other terminal of the first capacitor and to one terminal of the first transistor; and
one terminal of the third capacitor is connected to an actuating power supply, and the other terminal of the third capacitor is connected to one terminal of the third transistor and to the third shutter member;
the other terminal of the third transistor is connected to a common electrode; and
the input terminal of the inverter circuit is connected to the gate of the first transistor, and the output terminal of the inverter circuit is connected to a gate of the third transistor.

5. A pixel circuit has set forth in claim 4, wherein:
the inverter circuit is a CMOS; and
a common gate of the CMOS is connected to a gate of the first transistor, one terminal of the CMOS is connected to the second shutter power supply, and the other terminal of the CMOS is connected to a common electrode.

6. A display device comprising:
a plurality of pixels each disposed corresponding to an intersection between a plurality of data lines and a plurality of gate lines, disposed on a substrate; and
a pixel circuit as set forth in any one of claim 1 through claim 5, disposed at the pixels.

7. A display device as set forth in claim 6, wherein:
the shutter portion has a first shutter member that has an opening portion, a second shutter member that has a first spring that is connected to a shutter and a first anchor that is connected to the first spring, a second spring that is connected to the shutter, and a second shutter member that is connected to the second spring; and
the first spring and the second spring are electrostatically driven by a potential difference between the first anchor and the second anchor.

8. A display device as set forth in claim 7, wherein:
an electropotential difference between the first anchor and the second anchor is supplied by the pixel circuit.

9. A display device as set forth in any one of claim 6 through claim 8, further comprising:
an opposing substrate that has a light transmitting portion, and that is bonded to the substrate; and
a backlight that is disposed facing the opposing substrate; wherein:
light that is supplied from the backlight passes through a part wherein an opening portion of the first shutter member overlaps a light transmitting portion of the opposing substrate.
